(19) United States
(12) Patent Application Publication
(10) Pub. No.: US 2012/0182320 A1
(43) Pub. Date: Jul. 19, 2012

(54) Utilizing Matrix Codes to Install a Display Device

(75) Inventors: William Michael Beals, Englewood, CO (US); Keith Gerhards, Parker, CO (US)

(73) Assignee: EchoStar Technologies LLC, Englewood, CO (US)

(21) Appl. No.: 13/006,270

(22) Filed: Jan. 13, 2011

(51) Int. Cl. G09G 5/00

(52) U.S. Cl. 345/655

(57) ABSTRACT

One embodiment described herein may take the form of a system or method utilizing one or matrix codes to aid in installing a display device. In one embodiment, the one or more matrix codes may be utilized to configure the transmission of the multimedia presentation based on the orientation of the display device. In general, the one or more matrix codes may be obtained and decoded by one or more devices such that the information contained within the matrix codes may be provided to an electronic device for configuration of the multimedia presentation. In another embodiment, the one or more matrix codes may be utilized to determine the resolution of the display device and/or, in yet another embodiment, the generated matrix codes may be configured to account for the resolution of an associated display device, such that matrix codes displayed on a low resolution display device may be larger than matrix codes displayed on a high resolution display.

### TECHNICAL FIELD

Embodiments disclosed herein relate generally to providing and displaying multimedia content, and more particularly to utilizing one or more matrix codes to aid in the installation of a display device to display the multimedia content provided to the display.

### BACKGROUND

Barcodes and other optical machine-readable data representations are often used in commerce to provide a quick method of obtaining information about a product or service. In general, a barcode consists of varying widths of lines that may be read by a scanner, where the widths and spaces between the lines of the barcode provide information, such as an identification number of a product. Because the information of a barcode is conveyed through the varying widths of the lines of the code, barcodes are often referred to as linear or one-dimensional (1D) codes. In more recent years, a matrix (or two-dimensional) code has been developed to provide additional information in the code by encoding information in both the width and height dimensions of the matrix. Matrix codes, one example of which is as a quick response (QR) code, generally consist of black modules arranged in a square pattern on a white background, the configuration of which provides information to a scanner or reader. In this manner, matrix codes may be utilized to convey information to any electronic device once obtained by the scanner or reader device.

### BRIEF SUMMARY

One implementation may take the form of a method for installing a display device. The method may include the operations of generating, utilizing an electronic device, one or more matrix codes wherein the one or more matrix codes include an indication of the orientation of the one or more matrix codes and transmitting, utilizing the electronic device, the one or more matrix codes to at least one display device. In addition, the method may include the operations of receiving, at the electronic device, the orientation information from a reader device and configuring a multimedia presentation in response to the orientation information to correctly orient the multimedia presentation displayed on a display device.

Another implementation may take the form of a system for providing a multimedia presentation comprising an electronic device and at least one reader device. The electronic device may comprise at least one processing unit that generates one or more matrix codes including an indication of the orientation of the matrix codes and at least one output component in communication with a display device. In addition, the at least one processing unit may combine the one or more matrix codes with at least one multimedia presentation and transmit the combined one or more matrix codes and multimedia presentation to the display device utilizing the output component. The at least one reader device may comprise at least one optical input device that detects the one or more matrix codes displayed on the display device, at least one processing unit configured to decode the one or more matrix codes to obtain the indication of the orientation of the one or more matrix codes and at least one communication component configured to transmit the orientation of the one or more matrix codes to the electronic device. In addition, the electronic device may electronically orient one or more multimedia presentations transmitted through the one output component based on the received orientation of the one or more matrix codes.

Yet another implementation may take the form of a method for determining the resolution of a display device. The method may include the operations of generating, utilizing an electronic device, a matrix code, combining, utilizing the electronic device, the matrix code with a multimedia presentation, wherein the matrix code has a first size and transmitting, utilizing the electronic device, the combined matrix code and the multimedia presentation to at least one display device. The method may also include the operations of receiving, from a reader device, an indication that the matrix code is of the first size and assigning a first resolution to the display device based on the first size of the matrix code.

### BRIEF DESCRIPTION OF THE DRAWINGS

FIG. 1 is a block diagram illustrating a system for providing a multimedia presentation and for utilizing one or more matrix codes for installing a display device as part of the system.

FIG. 2 is a flowchart depicting a method for a system to generate one or more matrix codes to determine an orientation of a display device and configure a multimedia presentation in response to the determined orientation.

FIG. 3 is a diagram of a display device displaying a multimedia presentation and a matrix code with the display device rotated 90 degrees.

FIG. 4 is a diagram of the display device of FIG. 3 displaying a multimedia presentation configured to account for the orientation of the display device.

FIG. 5 is a flowchart depicting a method for utilizing one or more matrix codes to determine an approximate resolution of a display device.

FIG. 6 is a diagram of a display device displaying a multimedia presentation and a first size of a matrix code in response to the resolution of the display device.

FIG. 7 is a diagram of a display device displaying a multimedia presentation and a second size of a matrix code in response to the resolution of the display device.

FIG. 8 is a diagram of a display device displaying a multimedia presentation and a third size of a matrix code in response to the resolution of the display device.

### DETAILED DESCRIPTION

One embodiment described herein may take the form of a system or method for generating one or more matrix codes that may then by obtained by a reader device, the one or more matrix codes including information that may be utilized to install a display device such that a multimedia presentation may be displayed on the display device. In one embodiment, the one or more matrix codes may be utilized by the system to configure the orientation of the transmission of the multimedia presentation in response to a determined orientation of the display device. In general, the one or more matrix codes may be obtained and decoded by one or more devices such that the orientation of the code, and thereby the orientation of the display device, may be determined. This orientation information may then be provided to an electronic device such that the electronic device may configure the transmission of a multimedia presentation to account for the orientation of the display device. In another embodiment, the one or more matrix codes may be utilized to determine or approximate the resolution of the display device. In still another embodiment, the generated matrix codes may be configured to account for the resolution of an associated display device, such that matrix codes displayed on a low resolution display device may be larger than matrix codes displayed on a high resolution display.

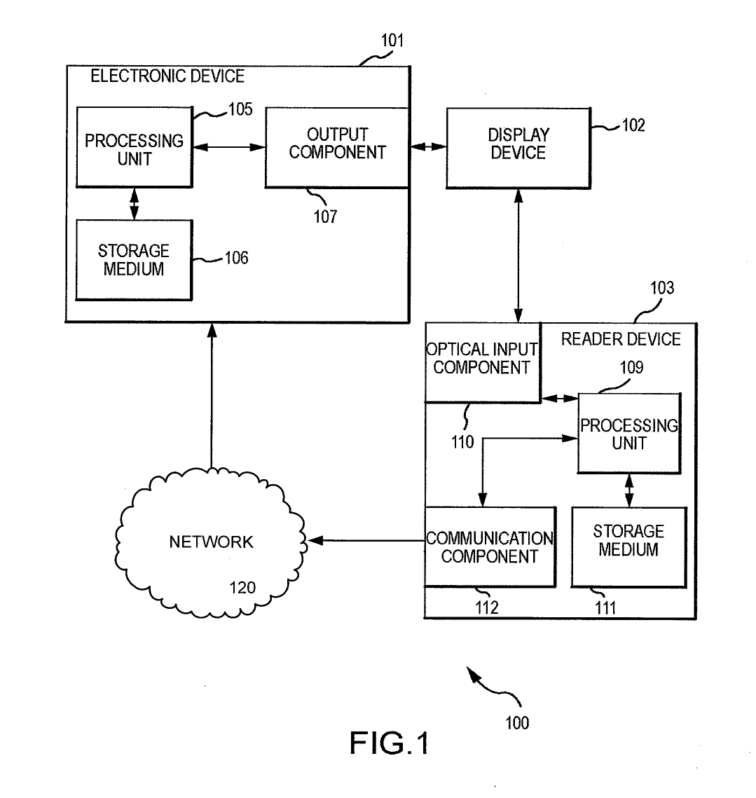

FIG. 1 is a block diagram illustrating a system 100 for providing a multimedia presentation on a display device 102 and for utilizing one or more matrix codes to install the display device. In general, the system 100 may include a electronic device 101 (which may be any kind of electronic device such as a television, a television receiver, a digital video recorder, a digital video disc player, an automobile, a computing device, a telephone, a kitchen appliance, a video game system, a security system, and so on), at least one display device 102 (which may be any kind of display device such as a cathode ray tube display, a liquid crystal display, a television, a computer monitor, a projector display, and so on), and a reader device 103 (which may be any type of device capable of detecting and decoding a matrix code such as a mobile telephone equipped with a camera, a mobile computing device that includes a camera, a remote control and so on). One or more networks may also be included in the system (illustrated as a single network 120 in FIG. 1) for receiving information from the reader device 103 and/or providing information or multimedia presentations to the electronic device 101 for display on the display device.

The electronic device 101 may include one or more processing units 105, one or more non-transitory storage media 106 (which may take the form of, but is not limited to, a magnetic storage medium; optical storage medium; magneto-optical storage medium; read only memory; random access memory; erasable programmable memory; flash memory; and so on), and one or more output components 107. The output components 107 may be configured to communicate with a display device 102, including providing one or more matrix codes for display on the display device in addition to providing a multimedia presentation to the display. Additionally, although the display device 102 is illustrated as separate from the electronic device, it is understood that in various implementations of the system, the display device may be incorporated into the electronic device. The processing unit 105 of the electronic device 101 may execute instructions stored in the non-transitory storage medium 106 to dynamically generate one or more matrix codes (such as one or more QR codes), provide one or more multimedia presentations to the display and transmit the dynamically generated matrix codes and multimedia presentations to the display device 102 utilizing the output component 107.

In one embodiment, the electronic device 101 may be a receiver of a multimedia presentation distribution system. In such an embodiment, the receiver 101 of the system may receive an encrypted signal of a multimedia presentation and convert it into a signal that a display or other compatible device may recognize and manipulate in order to present the multimedia presentation to one or more users. In addition, the receiver 101 may provide the converted signal to a display device 102, such as a television or computer screen, for display to the user. In one implementation, the receiver 101 may receive the encrypted signal from a satellite or through a digital cable or network connection, collectively shown in FIG. 1 as network 120.

A reader device 103 may also be included in the system and may detect the one or more matrix codes displayed by the display device 102. The reader device may also decode the information contained within the obtained matrix codes, such as information concerning the electronic device and/or a multimedia presentation provided by the electronic device 101. The reader device may include one or more processing units 109 which execute instructions stored in one or more non-transitory storage media 111 in order to receive the one or more matrix codes and either provide the received matrix codes to the network 120 or decode the information within the matrix codes. In addition, the reader device may interpret the information or the matrix codes to determine an orientation of the codes or an approximate resolution of the display device. The reader device may also include an optical input device 110 (such as a camera, a barcode scanner, and so on) for detecting the matrix code displayed by the display device as well as a communication component 112 for communicating with one or more networks to provide the obtained matrix codes or decoded information to one or more networks 120.

One or more networks 120 may also be included in the system 100. The networks 120 may communicate with electronic device 101 and/or the reader device 103. In one implementation when communicating the with reader device 103, the network 120 may receive the obtained matrix code. In another implementation, the network may receive the information contained within the obtained matrix codes after such information is decoded from the matrix code by the reader device 103. In addition, the network may provide information, such as the information received from the reader device 103 and obtained from the matrix code, to the electronic device 101. Further, in the implementation where the electronic device 101 is a receiver of a multimedia distribution system, the network 120 may also provide one or more multimedia presentations for display on the display device 102. As should be appreciated, the transmission of information to or from the network may occur in any manner known or hereafter developed, including but not limited to, transmission through a network connection or a wireless transmission.

In various implementations, the electronic device 101 may transmit the one or more matrix codes by themselves to the display device 102 via the output component 107 for the display device to display only the one or more matrix codes at a particular time. However, in various other implementations (such as implementations where the electronic device is a television receiver, digital video recorder, or other such device that provides images to a display), the electronic device may transmit one or more images (such as a video stream of a multimedia presentation) to the display device via the output component. In such implementations, the electronic device may combine the one or more matrix codes with the one or more images and transmit the combination to the display device via the output component.

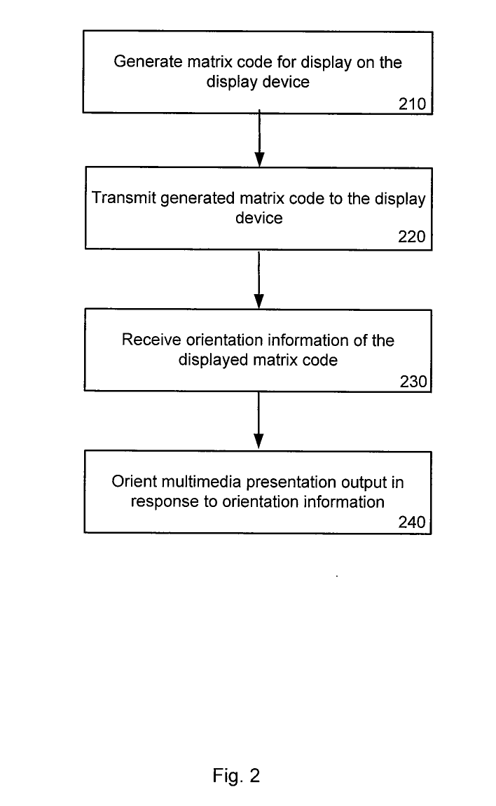

As mentioned above, the one or more matrix codes generated by the electronic device may be used to configure and/or install a display device into the system. FIG. 2 is a flowchart depicting a method for the system (such as that illustrated in FIG. 1) to generate one or more matrix codes to aid the electronic device in determining an orientation of a display device and configure a multimedia presentation in response to the determined orientation. In one example, the method of FIG. 2 may be utilized by a multimedia distribution system to orient a multimedia presentation on a projector display device that may be oriented in several configurations.

Beginning in operation 210, the electronic device may generate a matrix code for display on the display device. In general, the generated matrix code may include any information pertinent to the orientation of the matrix code encoded within the code. For example, the matrix code may include information that indicates which edge of the generated code is the upper edge of the code or the bottom edge of the code. In other implementations, the information encoded within the matrix code may not be necessary to determine the orientation of the matrix code as such orientation may be derived from the matrix code itself without decoding the information contained therein. For example, a matrix code, such as a QR code, may have a particular pattern common to each QR code that may aid a reader device in interpreting the code and may further indicate to a reader device the proper orientation of the matrix code. In other words, the pattern standard to each QR code may indicate the top edge of the matrix code, regardless of the orientation of the QR code and without the need to decode the information within matrix code itself.

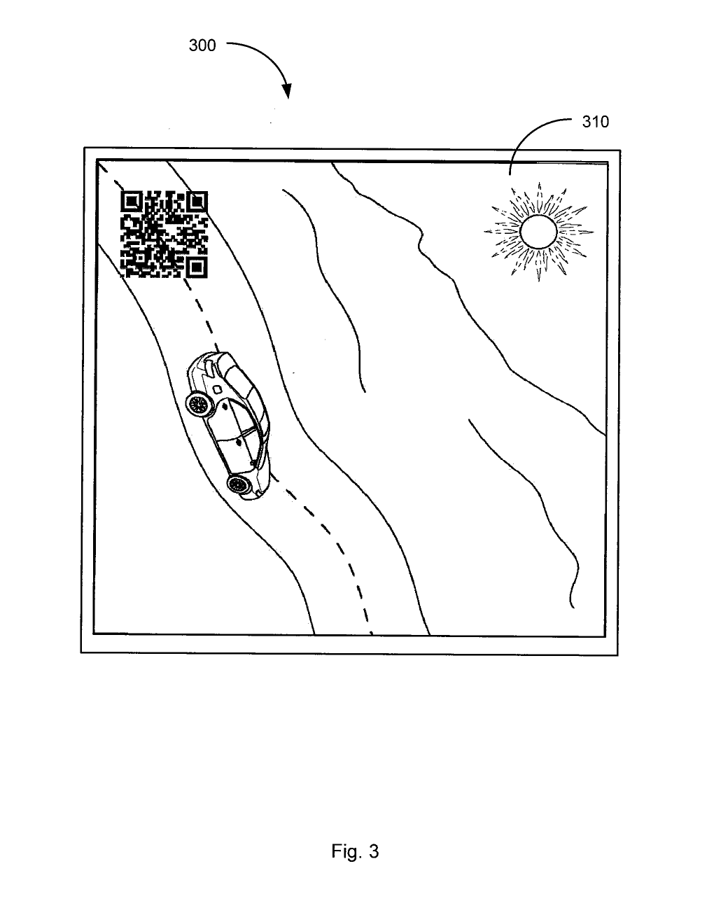

In operation 220, the electronic device may transmit the generated matrix code to a display device for display on the display device. As mentioned above, the matrix code may be displayed alone on the display device or may be incorporated into another image, such as into an image or frame of a video component of a multimedia presentation. Further, the electronic device may not be aware of the orientation of the display device such that the transmitted matrix code and/or multimedia presentation may appear rotated or flipped when transmitted to the display device and displayed. For example, FIG. 3 is a diagram of a display device 300 displaying a multimedia presentation 310 and a matrix code 320, wherein the display device is rotated 90 degrees. Such an orientation of the multimedia presentation 310 and matrix code 320 may occur when the display device 300 is installed in a non-standard upright manner. For example, some projector display devices may be configured to be installed on a table or to be hung from a ceiling to project the image onto a wall or screen. However, in the configuration where the projector is hung from the ceiling, the projected picture may appear rotated by 180 degrees from the projected picture when the projector is installed on the table. In another example, a computer screen display device may be installed in a vertical or horizontal orientation, as desired by the viewer of the computer screen. However, if the electronic device or display device is unaware of the orientation of the computer screen or projector in these examples, the displayed image may appear rotated, as it does in FIG. 3. Further, any matrix code 320 similarly displayed on the display device 300 may also appear rotated based on the orientation of the display device.

In yet another example, a front projector may be utilized as a rear projector such that the multimedia presentation may appear flipped when viewed on the display device. To account for this configuration, the presentation may be projected as a mirror image to account for the rear-projected installation. Further still, not only may the presentation appear flipped, but in some configurations, the presentation may also appear rotated, such as when a projector is installed as described above and in the rear-projection orientation. In general, the presentation on the display device may appear in any orientation, including rotated, flipped or a combination.

To provide orientation information of the display device to the electronic device, the reader device may obtain the orientation information by obtaining and analyzing the displayed matrix code in operation 230. As described above, the reader device may obtain the matrix code from the display device by capturing a still image or video of the display screen. Further, the reader device may be configured to locate a matrix code embedded within a displayed image or frame of a video component of a multimedia presentation. To obtain the matrix code from an image, the reader device may utilize image recognition technology to isolate the matrix code and ignore the portions of the image not including the matrix code. For example, the reader device may utilize edge detection technology to analyze the captured image and detect the edges of the matrix code to isolate the code. In another example, the reader device may conduct a pattern recognition analysis on the captured image to detect the matrix code.

Once the matrix code is obtained from the display device, the reader device may analyze the code to determine the orientation of the obtained matrix code. In the example where the orientation information may be contained within the encoded information of the code, the reader device may decode the matrix code and obtain the orientation information. For example, the information encoded within the matrix code may indicate a particular edge of the matrix code as the upper edge of the code. Once this information is decoded, the orientation of the matrix code may be determined by the reader device. In another embodiment, such as when a QR code or similar matrix code is utilized, the pattern of the QR code itself may indicate the upper edge of the code or whether the matrix code is flipped. Thus, in this embodiment, the orientation of the matrix code may be determined through a simple analysis of the pattern of the code, with no need for decoding of the code or retrieval of the stored information.

Although described above with reference only to a reader device, one of several components of the exemplary system may be utilized to determine the orientation of the obtained matrix code. For example, in one embodiment, the obtained matrix code may be transmitted as obtained to the network for analysis to determine the code's orientation. In another embodiment, the orientation information may be transmitted to the network and, ultimately, to the electronic device for analysis. In yet another embodiment, the obtained matrix code may be transmitted unanalyzed through the network to the electronic device for analysis and determination of the matrix code orientation.

In operation 230, the orientation information of the matrix code and display device may be transmitted to and received by the electronic device. As described above, in one embodiment the orientation information may be determined by the reader device or the network. In an alternate embodiment, the orientation information may be derived by the electronic device itself after an analysis of the matrix code obtained from the display device. Regardless, once the orientation information is received or derived, the electronic device may determine the orientation of the display device, as the orientation of the display device may be the same as or similar to the orientation of the obtained matrix code.

In operation 240, the electronic device may utilize the received or derived orientation information of the matrix code to configure a multimedia presentation output transmitted to the display device. In one implementation, the electronic device may rotate the multimedia presentation to account for the received orientation information prior to transmission of the presentation to the display device. For example, if the orientation information indicates that the matrix code is rotated 90 degrees in a clockwise manner, the electronic device may rotate the multimedia presentation output counter-clockwise by 90 degrees to compensate for the orientation of the display device. Similarly, a matrix code rotated 180 degrees may cause the electronic device to rotate the multimedia output by 180 degrees to compensate for the installed orientation of the display device. In another implementation, the electronic device may flip the multimedia presentation to account for a flipped presentation. In yet other implementations, the orientation information may be provided to the display device along with an unaltered multimedia presentation such that the display device may rotate or flip the multimedia presentation in response to the orientation information.

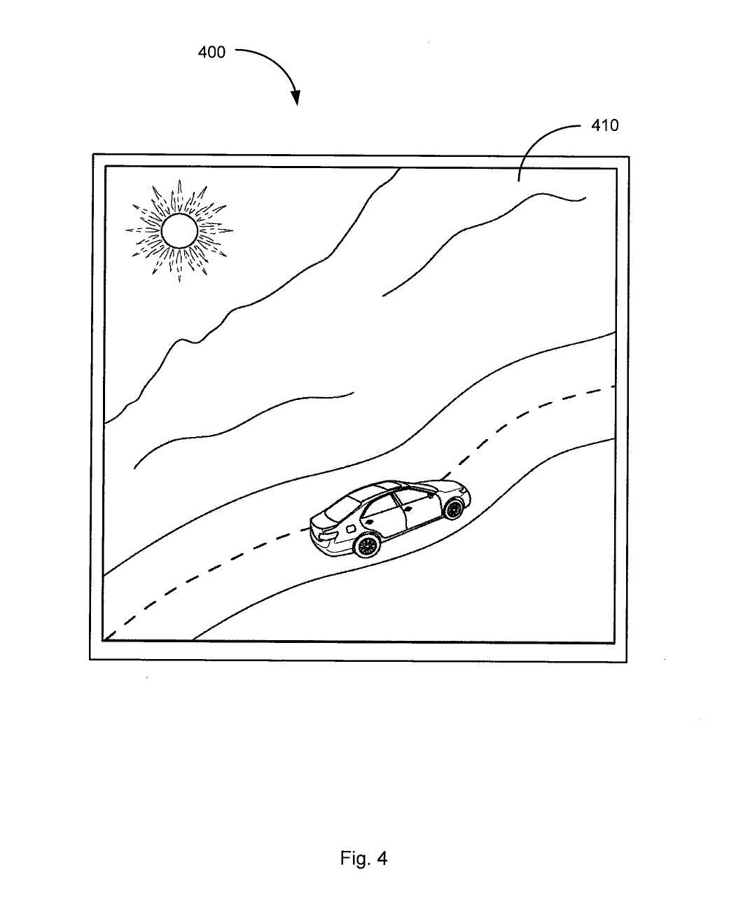

Returning to the example illustrated in FIG. 3, the matrix code 320 displayed on the display device 300 is illustrated as being rotated 90 degrees in a clockwise direction from center. Thus, once the orientation of the matrix code 320 is determined to be so rotated through the operations described above, the system may similarly determine that the display device 300 is installed or configured in a manner rotated clockwise by 90 degrees. With this information, the electronic device may configure the multimedia presentation output to compensate for the rotated display device. For example, FIG. 4 is a diagram of the display device 400 of FIG. 3 displaying a multimedia presentation 410 that has been configured (or rotated) to account for the orientation of the installed display device. As shown in FIG. 4, the multimedia presentation 410 is rotated 90 degrees counter-clockwise to account for rotated installation of the display device 400.

Once the orientation of the display device is determined, the matrix code of FIG. 3 may or may not continue to be included in the reconfigured multimedia output shown on the display device. In one embodiment, the electronic device may maintain an indication of the orientation of the display device such that the orienting matrix code may no longer be needed. In another embodiment, the orienting matrix code may be retransmitted to the display device upon a request by a user of the system, such as during installation or updating of the system. In another embodiment, the orienting matrix code may be periodically displayed on the display device by the electronic device to continually confirm the proper orientation of the multimedia presentation. Thus, by performing the operations described above in FIG. 2, a multimedia system may utilize one or more matrix codes to orient a multimedia output for proper display of the presentation on a display device.

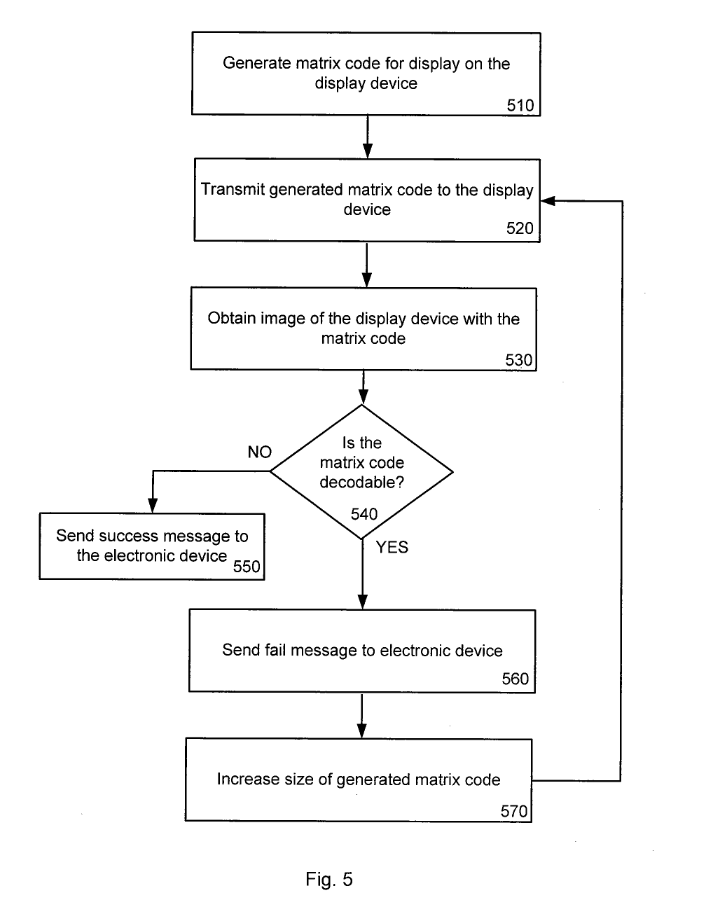

In a similar manner, the system may utilize one or more displayed matrix codes to determine the resolution or an approximate resolution of a display device, in addition to determining the display device orientation. FIG. 5 is a flowchart depicting a method for utilizing one or more matrix codes to determine an approximate resolution of a display device. In general, the operations of 510 and 520 may be similar to the corresponding numbered operations of FIG. 2. Thus, in operation 510 the electronic device may generate a matrix code with any information encoded therein. Also, in operation 520, the generated matrix code may be transmitted to the display device for display.

Continuing to operation 530, the reader device may obtain an image of the display device as the matrix code is displayed. As mentioned above, the reader device may take a image or video of the display device to obtain a matrix code displayed on the display device. Further, the reader device may utilize one or more image detection techniques described above to isolate the matrix code contained within the image. Also in operation 530, the reader device may attempt to decode the matrix code displayed on and obtained from the display device.

In operation 540, the reader device may determine if the obtained matrix code is decodable. Although several factors may contribute to the unreadability of the matrix code, one reason that the matrix code may not be decodable by the reader device may be because the resolution of the display device on which the matrix code is displayed may not be sufficient to display the pattern of the matrix code clearly. As should be appreciated, on high resolution displays, the pattern of the matrix code may appear clearer than on a lower resolution television. Thus, the inability of the reader device to decode the obtained matrix code in operation 540 may relate to the resolution and/or size of the display device.

If the reader device determines in operation 540 that the matrix code is decodable, the reader device may then decode the matrix code in operation 550 and send a success message to the electronic device. It should be appreciated, however, that any component of the system may decode the matrix code in operation 550, such as the network or the electronic device. In these embodiments, the matrix code may be provided by the reader device to a separate component for decoding. As explained in more detail below, the success message may aid the electronic device in approximating the resolution of the display device. Alternatively, if the reader device is unable to decode the matrix code in operation 540, the reader device may then proceed to operation 560 and generate a fail message to be sent to the electronic device.

In operation 560, a fail message may be transmitted to the electronic device indicating that the obtained matrix code may not be decoded by the reader device. The fail message may take any form that indicates to the electronic device that the matrix code cannot be decoded. In one example, the fail message may comprise a data bit, such as a flag bit contained within a data word transmitted to the electronic device over the network. Upon receipt of the fail message, the electronic device may increase the size of the generated matrix code in operation 570. In general, the increase in the size of the matrix code may be predetermined, such that when it is determined that the matrix code is unreadable, the electronic device may increase the size of the generated matrix code to the next determined dimension.

Further, the method may return to operation 520 such that the electronic device may then transmit the larger matrix code to the display device. In this manner, the above operations may be repeated such that the matrix code displayed on the display device may continue to be increased by the determined sizes until the reader device is capable of decoding the matrix code and the success message is transmitted to the electronic device. Thus, when the method is complete and the matrix code is properly sized, the electronic device may determine an approximate resolution for the display device. In general, each possible matrix code size may be associated with a resolution by the electronic device. For example, the smallest generated matrix code may be associated with a 1080p resolution display, while subsequently larger matrix codes may be associated with smaller resolution displays. In this manner, once the electronic device has determined the size of a matrix code that may be read by a reader device, the electronic device may assign an approximate resolution associated with the matrix code size to the display device. As a result, the electronic device may utilize the matrix codes to approximate the resolution of the display device. Such information may be useful by the electronic device in providing one or more multimedia presentations to be displayed on the display device.

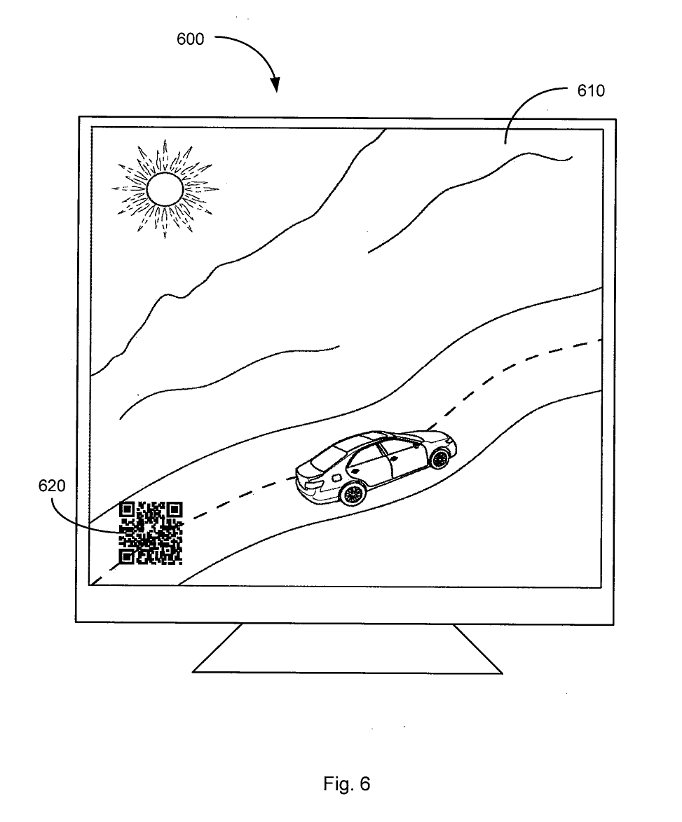

One example of the operations of the method illustrated in FIG. 5 is shown in FIGS. 6 through 8. FIG. 6 is a diagram of a display device 600 displaying a multimedia presentation 610 and a first size of a matrix code 620. As explained above, the matrix code 620 may be obtained by a reader device that may then attempt to decode the matrix code. However, if the resolution of the display device 600 is low, the pattern of the matrix code 620 displayed on the display may not be clear enough for the reader device to obtain the information encoded therein. Thus, a larger matrix code may be needed to properly convey the encoded information. Alternatively, for those display devices 600 with a high resolution, the displayed matrix code 620 may be sufficiently clear to be read and decoded by the reader device.

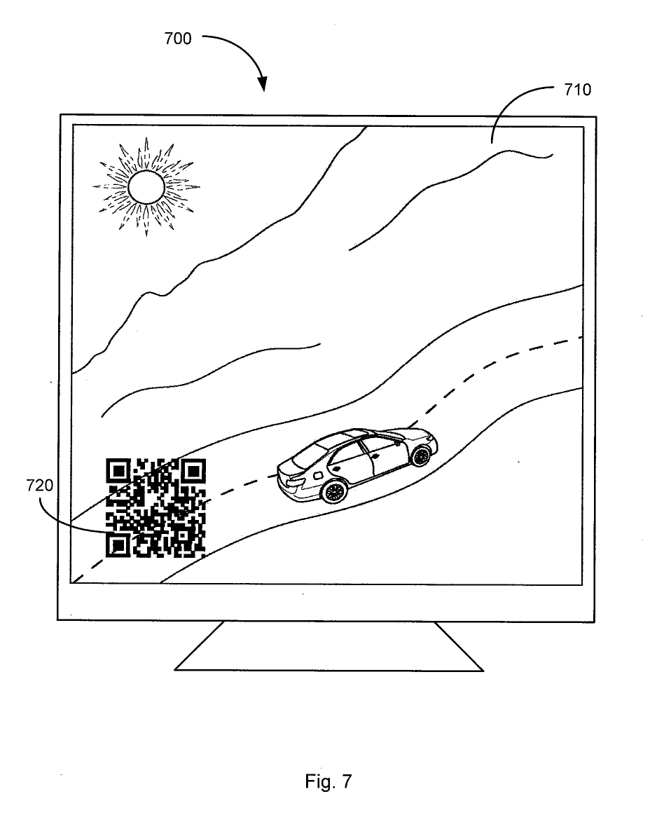

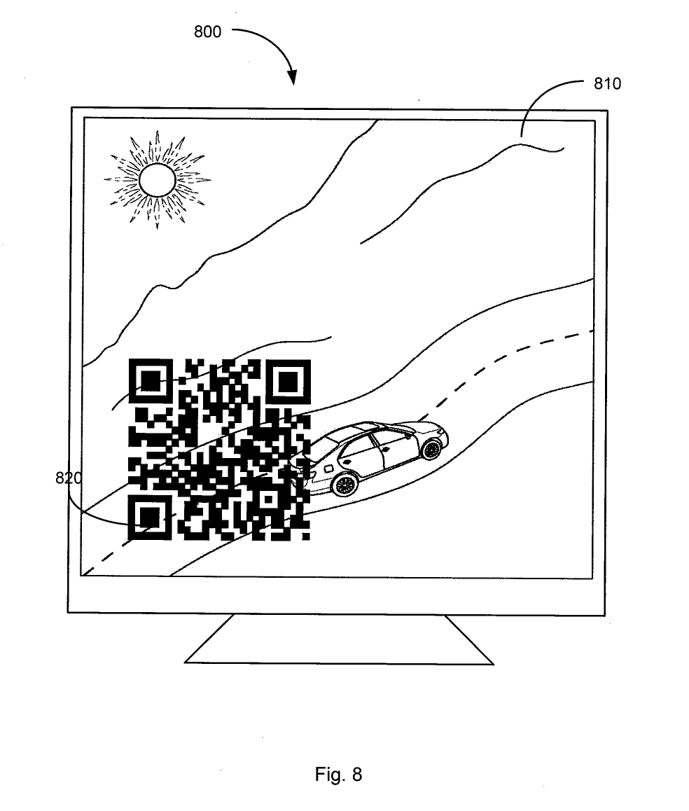

FIG. 7 is a diagram of a display device 700 displaying a multimedia presentation 710 and a second size of a matrix code 720 in response to the resolution of the display device. The example illustrated in FIG. 7 may be the result of the inability of the reader device decoding the matrix code at a smaller size due to the low resolution of the display device 700. Thus, utilizing the method described above with reference to FIG. 5, the electronic device may increase the size of the matrix code as shown in FIG. 6 to the size of the matrix code in FIG. 7. In general, the information contained within the matrix code 720 may be similar or the same between the two different sized codes. Rather, the matrix code may be larger to aid in the reader device obtaining the matrix code from a lower resolution display device 700. Similarly, FIG. 8 is a diagram of a display device 800 displaying a multimedia presentation 810 and a third size of a matrix code 820 in response to the determined resolution of the display device. The implementation illustrated in FIG. 8 may be for those display devices 800 with the lowest resolution.

In other embodiments, the resolution of the display device may be known by the electronic device such that the proper size of the displayed matrix code may be selected for display. Thus, a reader device may obtain and decode the displayed matrix code once the properly sized matrix code is determined. In these embodiments, the electronic device may receive the resolution of the display device in several manners. In one example, a user of the display device and/or electronic device may utilize an input device, such as a remote control, to communicate with the electronic device or display device to select the proper resolution of the display device, such as by selecting the resolution from a list of resolution options. In response, the selected resolution may be maintained by the electronic device for future use in selecting the matrix code size. As mentioned above, higher resolution displays may require a smaller matrix code to be readable.

In another example, the display device may provide the resolution information directly to the electronic device. For example, the electronic device and display device may be in communication, such as through a High Definition Multimedia Interface (HDMI cable). The HDMI cable may allow the display device to provide information to the electronic device, such as the display device's resolution. In this example, the display device may be configured to provide the display's resolution upon connection to the electronic device and such information may be maintained by the electronic device. Further, such information may be utilized by the electronic device to select a size for a displayed matrix code such that the matrix code may be read by a reader device.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to: a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined differently in various embodiments of the disclosure or described with different terminology. These and other variations, modifications, additions, and improvements may fall within the scope of the disclosure as defined in the claims that follow.

What is claimed is:

1. A method for installing a display device comprising;
generating, utilizing an electronic device, one or more matrix codes including an orientation indication of the one or more matrix codes;
transmitting, utilizing the electronic device, the one or more matrix codes to at least one display device;
receiving, at the electronic device, the orientation indication from a reader device; and
configuring, utilizing the electronic device, a multimedia presentation in response to the orientation indication to correctly orient the multimedia presentation displayed on a display device.

2. The method of claim 1 wherein the orientation indication is encoded within the one or more matrix codes.

3. The method of claim 1 wherein the orientation indication of the one or more matrix codes is contained within the pattern of the one or more matrix codes such that the indication is obtained without decoding the one or more matrix codes.

4. The method of claim 1 wherein the configuring operation comprises:
determining a rotational offset based on a desired orientation and the orientation indication;
and electronically rotating the multimedia presentation by the rotational offset, thereby creating a rotated multimedia presentation.

5. The method of claim 4 further comprising:
transmitting the rotated multimedia presentation to the at least one display device for display to a viewer.

6. The method of claim 1 wherein the receiving operation comprises:
obtaining the one or more matrix codes from the reader device;
analyzing the pattern of the one or more matrix codes to determine the upper edge of the one or more matrix codes; and
determining the orientation indication of the one or more matrix codes based on the position of the upper edge of the one or more matrix codes.

7. The method of claim 1 further comprising:
obtaining, utilizing the reader device, the one or more matrix codes from the at least one display device by acquiring a digital image of the at least one display device.

8. The method of claim 7 further comprising:
providing the indication of the orientation indication to the electronic device over a network.

9. A system for providing a multimedia presentation comprising:
an electronic device, comprising:
at least one processing unit that generates one or more matrix codes including an indication of the orientation of the matrix codes; and
at least one output component in communication with a display device;
wherein the at least one processing unit combines the one or more matrix codes with at least one multimedia presentation and transmits the combined one or more matrix codes and multimedia presentation to the display device utilizing the output component; wherein
the electronic device electronically orients one or more multimedia presentations transmitted through the one output component based on the received orientation of the one or more matrix codes.

10. The system of claim 9 further comprising:
a network configured to receive the indication of the orientation of the one or more matrix codes from the reader device and transmit the indication to the electronic device.

11. The system of claim 9 wherein the reader device obtains the one or more matrix codes from the display device by acquiring a digital image of the display device.

12. The system of claim 9 wherein the electronic device transmits the oriented one or more multimedia presentation to the display device for display to a user of the system.

13. The system of claim 12 wherein the electronic device removes the one or more matrix codes from the oriented one or more multimedia presentation prior to transmission to the display device.

14. The system of claim 9 wherein the orientation of the one or more matrix codes is the same as an orientation for the display device.

15. A method for determining the resolution of a display device, comprising:
generating, utilizing an electronic device, a matrix code;
combining, utilizing the electronic device, the matrix code with a multimedia presentation, wherein the matrix code has a first size;
transmitting, utilizing the electronic device, the combined matrix code and the multimedia presentation to a display device;
receiving, from a reader device, an indication that the matrix code is of the first size; and
assigning a first resolution to the display device based on the first size of the matrix code.

16. The method of claim 15 further comprising:
generating, utilizing the electronic device, a matrix code of a second size;
transmitting, utilizing the electronic device, the matrix code of the second size to a display device;
receiving, from a reader device, an indication that the matrix code is of the second size; and
assigning a second resolution to the display device based on the second size of the matrix code.

17. The method of claim 15 wherein the indication of the first size of the matrix code is transmitted by the reader device to the electronic device through a network connection.

18. The method of claim 15 further comprising:
combining the matrix code in the first size with the multimedia presentation prior to transmission to the at least one display device.

19. The method of claim 16 wherein the first resolution is higher than the second resolution.

20. The method of claim 15 wherein the indication that the matrix code is of the first size comprises a success message transmitted to the electronic device indicating that the matrix code of the first size is decodable.
